(19) United States
(12) Patent Application Publication
(10) Pub. No.: US 2015/0310550 A1
(43) Pub. Date: Oct. 29, 2015

(54) FOREIGN EXCHANGE TRADE SYSTEM, INFORMATION PROCESSING METHOD AND PROGRAM PRODUCT

(71) Applicant: NS SOLUTIONS CORPORATION, Tokyo (JP)

(72) Inventor: Hitoshi MINAMI, Tokyo (JP)

(21) Appl. No.: 14/663,148

(22) Filed: Mar. 19, 2015

(30) Foreign Application Priority Data
Apr. 25, 2014 (JP) 2014-091936

(51) Int. Cl. G06Q 40/04

(52) U.S. Cl. CPC G06Q 40/04

(57) ABSTRACT

A tradable price acquiring unit which acquires tradable prices from a plurality of market maker devices connected via a multibank portal in accordance with transaction condition information relating to a foreign exchange trade accepted from a customer device; and a tradable price for clients determining unit which determines a tradable price for clients of the foreign exchange trade presented to a customer via the customer device based on a plurality of tradable prices acquired by the tradable price acquiring unit, are included to thereby solve problems.

### CROSS-REFERENCE TO RELATED APPLICATIONS

This application is based upon and claims the benefit of priority of the prior Japanese Patent Application No. 2014-091936, filed on Apr. 25, 2014, the entire contents of which are incorporated herein by reference.

### BACKGROUND OF THE INVENTION

1. Field of the Invention

The present invention relates to a foreign exchange trade system, an information processing method and program.

2. Description of the Related Art

In recent years, a foreign exchange trade system using Internet has been widely used. A foreign exchange trade is a financial transaction performed by a company executing, for example, export-import transactions to reduce a currency risk generated by a difference of exchange market prices at a contract time and at a settlement time by contracting an exchange rate to be applied in advance when a certain currency is received and paid at a certain time in the future.

The foreign exchange trade system is provided by, for example, a financial institution such as a bank. In the foreign exchange trade system, distribution of an indicative price of exchange is performed for a user (for example, an export-import company). The user refers to the indicative price, and when the user wants to sell/buy the exchange, the user inputs a currency, a transaction amount, and so on being selling/buying targets to the foreign exchange trade system, and requests presentation of a tradable price for clients. The foreign exchange trade system presents the tradable price for clients based on input contents of the user. The tradable price for clients is a value in which spread and so on is added/subtracted for the indicative price. The spread is defined by each transaction partner in accordance with the currency and the transaction amount, and the tradable price for clients is determined by each bank according to its own rules.

The distribution of the, the presentation of the tradable price for clients, and so on of the foreign exchange trade system are generally enabled by the financial institution such as the bank establishing an individual software interface with a plurality of market makers.

[Patent Document 1] Japanese Laid-open Patent Publication No. 2012-27516

[Patent Document 2] Japanese Laid-open Patent Publication No. 2002-207880

However, the individual software interface costs enormously such as a development cost, a maintenance cost, and so on of the individual system, and therefore, it is actually difficult for banks other than large-scale financial institutions to establish the software interface with the plurality of market makers. Accordingly, when a local bank and so on execute a foreign exchange trade transaction using the foreign exchange trade system, it is assumed to establish the software interface and execute the transaction only with a specific market maker. However, the local bank presents its own tradable price for clients based on only a rate presented by the specific market maker, and therefore, it is not necessarily able to present a proper tradable price for clients, and there is a problem that a contract of the foreign exchange trade transaction is difficult to be engaged with the customer (user).

Besides, it is necessary to execute a cover deal in accordance with contents of the foreign exchange trade transaction with the customer, with the other market maker, but when the cover deal is executed automatically, the transaction is executed with the specific market maker which is in the software interface relationship, a client of the cover deal is limited, and therefore, there is a problem that it is not necessarily possible to execute the cover deal under an advantageous condition.

### SUMMARY OF THE INVENTION

An object of the present invention is to provide a foreign exchange trade system capable of executing a more proper foreign exchange trade transaction even if the financial institutions such as the local banks do not individually establish the software interface with each of the plurality of market makers.

A foreign exchange trade system according to the present invention includes: a tradable price acquiring unit which acquires tradable prices from a plurality of market maker devices connected via a multibank portal in accordance with transaction condition information relating to a foreign exchange trade accepted from a customer device; and a tradable price for clients determining unit which determines a tradable price for clients of the foreign exchange trade presented to a customer via the customer device based on a plurality of tradable prices acquired by the tradable price acquiring unit.

### BRIEF DESCRIPTION OF THE DRAWINGS

FIG. 1 is a view illustrating an example of a system configuration.

FIG. 2 is a view illustrating an example of a hardware configuration.

FIG. 3 is a view illustrating an example of a functional configuration according to an embodiment 1.

FIG. 4 is a flowchart illustrating an example of processes according to the embodiment 1.

FIG. 5A is a view illustrating an example of an input screen of a foreign exchange trade transaction.

FIG. 5B is a view illustrating an example of the input screen of the foreign exchange trade transaction.

FIG. 5C is a view illustrating an example of the input screen of the foreign exchange trade transaction.

FIG. 6 is a view illustrating an example of transaction condition information of the foreign exchange trade transaction.

FIG. 7 is a view illustrating an example of a list of tradable prices of the foreign exchange trade transaction.

FIG. 8 is a view illustrating an example of an input screen of the foreign exchange trade transaction.

FIG. 9A is a view illustrating an example of a confirmation screen of the foreign exchange trade transaction.

FIG. 9B is a view illustrating an example of the confirmation screen of the foreign exchange trade transaction.

FIG. 10 is a view illustrating an example of a functional configuration according to an embodiment 2.

FIG. 11 is a flowchart illustrating an example of processes according to the embodiment 2.

### DETAILED DESCRIPTION OF THE PREFERRED EMBODIMENTS

Hereinafter, embodiments according to the present invention will be described with reference to the drawings.

### Embodiment 1

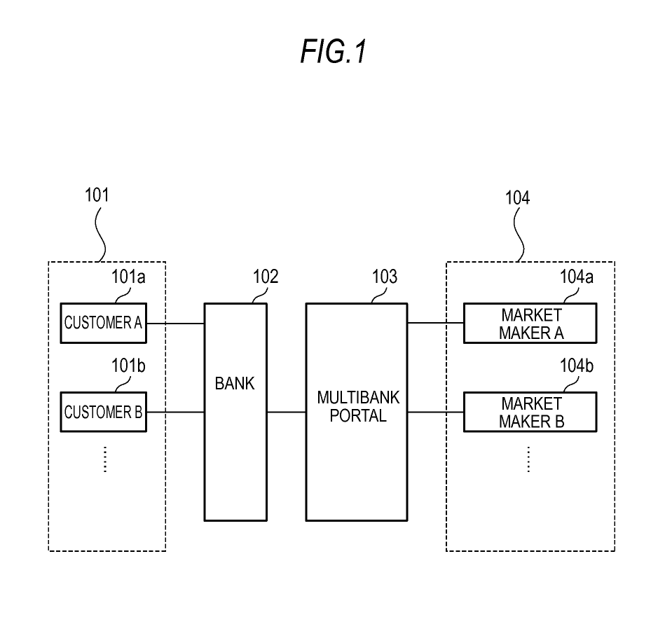

FIG. 1 is a view illustrating an example of a system configuration of the present embodiment.

In a system of the embodiment, a customer device 101 of a customer such as an export-import company and so on and a multibank portal 103 which mediates transactions between a bank and a plurality of market makers are connected to a foreign exchange trade system 102 provided by the bank (a financial institution) via a network. Besides, market maker devices 104 of the plurality of market makers are connected to the multibank portal 103.

The customer device 101 is an information processing device such as a PC, a server device, and so on connected to a customer's network. Here, customer devices at a customer A, a customer B are respectively set to be a customer device 101a, a customer device 101b, and they are collectively called as the customer device 101. The number of customer devices 101 connected to the foreign exchange trade system 102 may be one, or may be plural.

The foreign exchange trade system 102 is a cloud system providing services relating to a foreign exchange trade transaction. In the following description, it is described on an assumption that services relating to the foreign exchange trade transaction are provided by an administration server device included in the foreign exchange trade system 102 executing processes while administering processes executed by the other server devices and so on included in the foreign exchange trade system 102. Note that it may have a constitution in which a plurality of server devices included in the foreign exchange trade system 102 work with each other to execute processes, or a constitution in which one server device in which functions of the foreign exchange trade system 102 are integrated executes the processes. Note that when it is referred to as the administration server device in the following description, it means the administration server device of the foreign exchange trade system 102.

The multibank portal 103 is made up of one or a plurality of server devices and so on, and it mediates exchange of information between the foreign exchange trade system 102 and the plurality of market maker devices 104.

The market maker device 104 is the information processing device such as the PC, the server device, and so on connected to the network of the market maker. Here, the market maker devices at a market maker A, at a market maker B are respectively called as a market maker device 104a, a market maker device 104b, and they are collectively called as the market maker device 104. Here, it is assumed that the plurality of market maker devices 104 are connected to the multibank portal 103.

The foreign exchange trade system 102 of the embodiment acquires an indicative price of foreign exchange (hereinafter, it is just called as exchange) from the market maker device 104 via the multibank portal 103, and presents to the customer device 101. The foreign exchange trade system 102 accepts transaction condition information relating to a transaction condition of a foreign exchange trade from the customer device 101, then acquires tradable prices from the plurality of market maker devices 104 via the multibank portal 103. Further, the foreign exchange trade system 102 determines a tradable price for clients based on the acquired plurality of tradable prices, and presents to the customer device 101.

Here, the indicative price in the embodiment is an exchange rate (exchange market price) determined at an interbank market based on the exchange transactions and so on between interbank. Besides, the tradable price in the embodiment is a rate of the exchange transaction presented by the market maker in accordance with transaction conditions such as a transaction currency and a transaction amount. Besides, the tradable price for clients in the embodiment is a tradable price presented by a bank to customers based on the tradable price presented by the market maker, and spread and so on peculiar to the bank may be added/subtracted thereto. Note that the spread is a difference of prices between a selling price and a buying price (selling price−buying price).

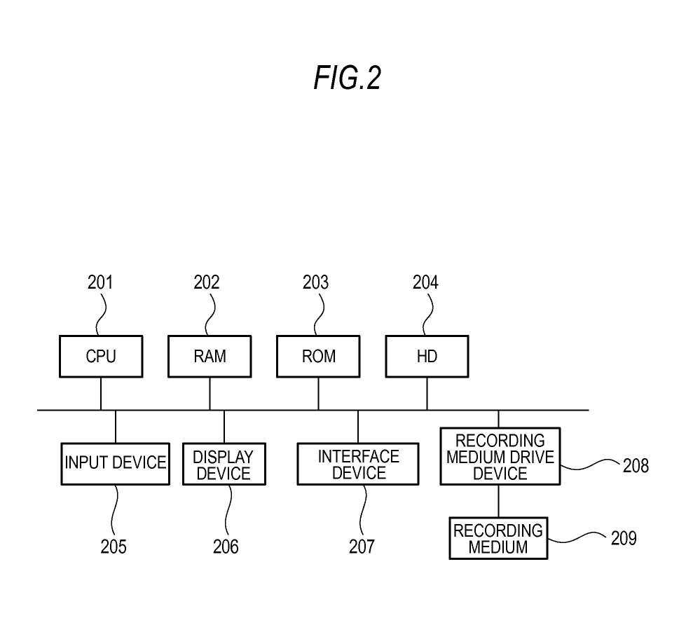

FIG. 2 is a view illustrating an example of a hardware configuration of the administration server device included in the foreign exchange trade system 102. As stated above, the administration server device included in the foreign exchange trade system 102 administers the processes executed by the other server devices and so on included in the foreign exchange trade system 102.

The administration server device has a CPU (Central Processing Unit) 201, a RAM (Random Access Memory) 202, a ROM (Read Only Memory) 203, an HD (Hard Disk) 204, an input device 205, a display device 206, an interface device 207, and a recording medium drive device 208. Note that the other server devices and so on included in the foreign exchange trade system 102 have similar hardware configurations.

The CPU 201 stores programs read out of the HD 204 and the ROM 203 to the RAM 202 and executes, and thereby, enables processes (information processes) relating to a later-described functional configuration of the administration server device and a flowchart of the foreign exchange trade system 102. The RAM 202 is a main memory of the administration server device. The ROM 203 stores the programs and so on which are first read at a power on time of the administration server device. The HD 204 stores various kinds of programs and various kinds of data containing data such as threshold values required for processes executed by the CPU 201.

The input device 205 is made up of a keyboard, a mouse, and so on operated by an administrator and so on of the foreign exchange trade system 102, and is used to input various operation information and so on to the administration server device. Note that the administrator in the following description means an administrator of the foreign exchange trade system 102. The display device 206 is made up of a display and so on used by the administrator, and is used to display various information, screens or the like. Note that the display device 206 may be a touch panel and so on which can be operated by touching the display. The interface device 207 is an interface which connects the administration server device to the network and so on. The programs of the administration server device are provided to the administration server device by, for example, a recording medium 209 such as a CD-ROM, or downloaded via the network and so on. The recording medium 209 is set at the administration server device, and the programs are installed from the recording medium 209 to the HD 204 via the recording medium drive device 208.

Note that the hardware configurations of the customer device 101, the multibank portal 103, and the market maker device 104 of the embodiment are the configurations similar to the hardware configuration illustrated in FIG. 2. Namely, each device described above enables functions of each device by reading the programs from the HD 204 and the ROM 203 of each device and executing them.

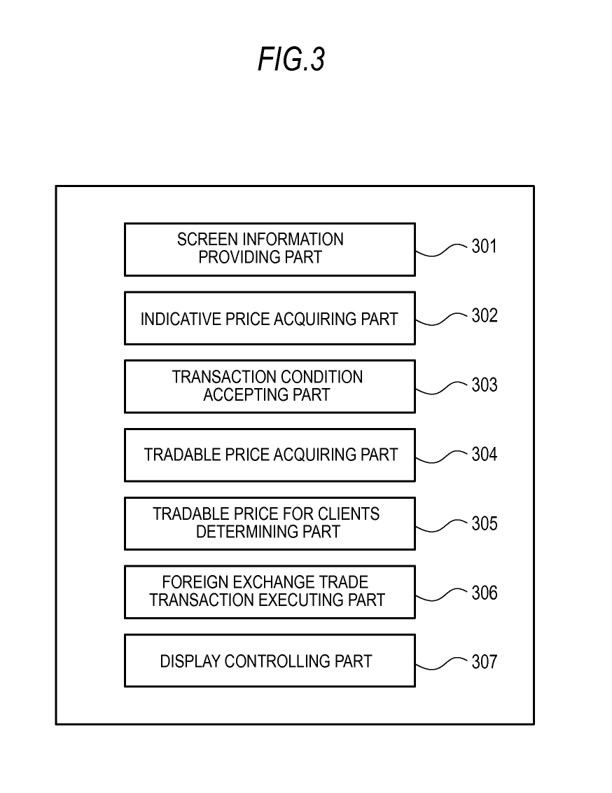

FIG. 3 is a view illustrating an example of the functional configuration of the administration server device included in the foreign exchange trade system 102 of the embodiment.

A screen information providing part 301 transmits screen information to display a screen presenting various information for the customer to the customer device 101. The screen information described here may be information to display, for example, a homepage screen, or may be configuration information of a screen required for displaying the screen. The customer is thereby able to perform operations relating to the foreign exchange trade transaction while confirming the displayed screen based on the screen information accepted from the screen information providing part 301 by the customer device 101.

An indicative price acquiring part 302 acquires the indicative price from the market maker device 104 via the multibank portal 103 in accordance with a request from the customer device 101. Here, the indicative price acquiring part 302 may acquire the indicative price from any of the market maker devices 104.

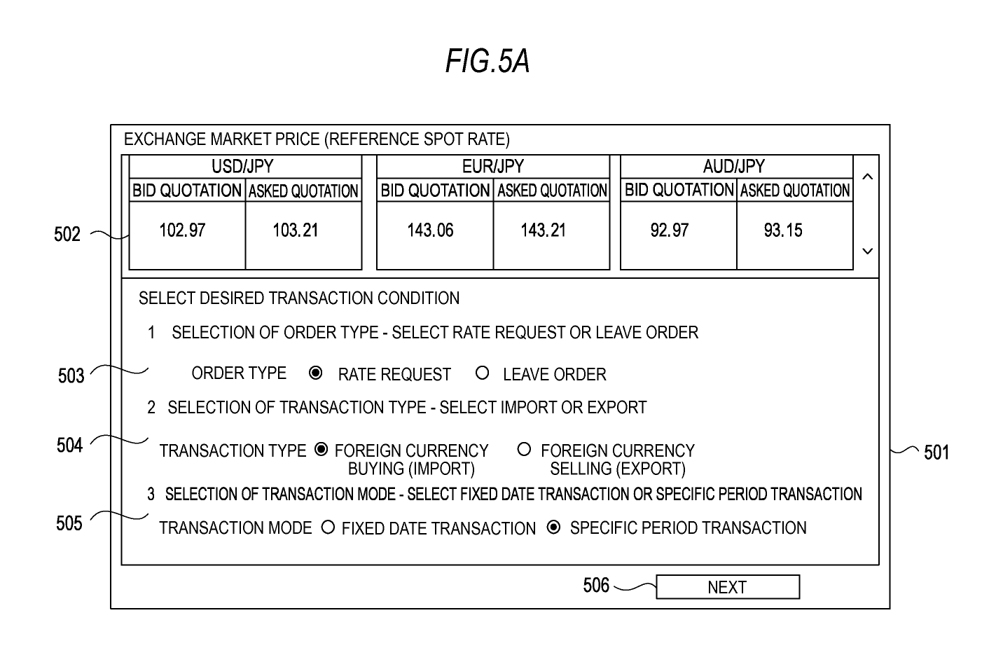

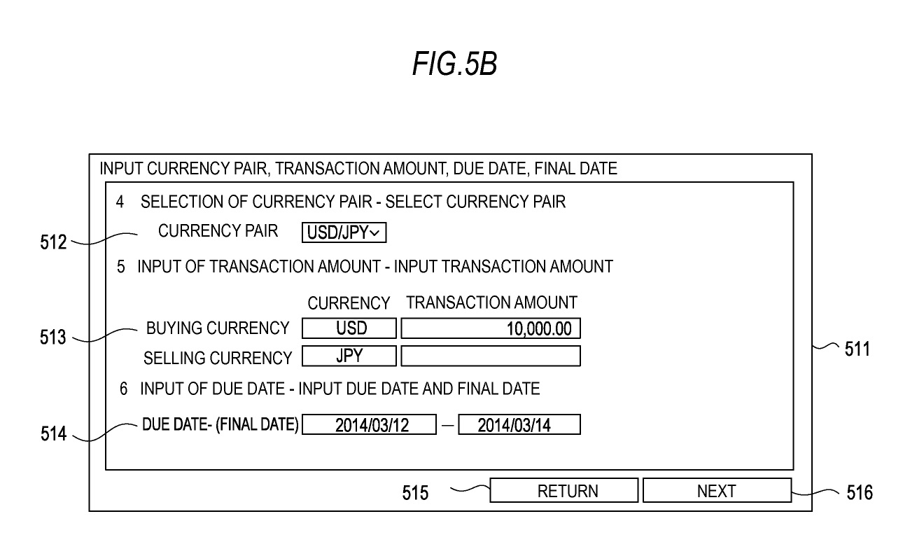

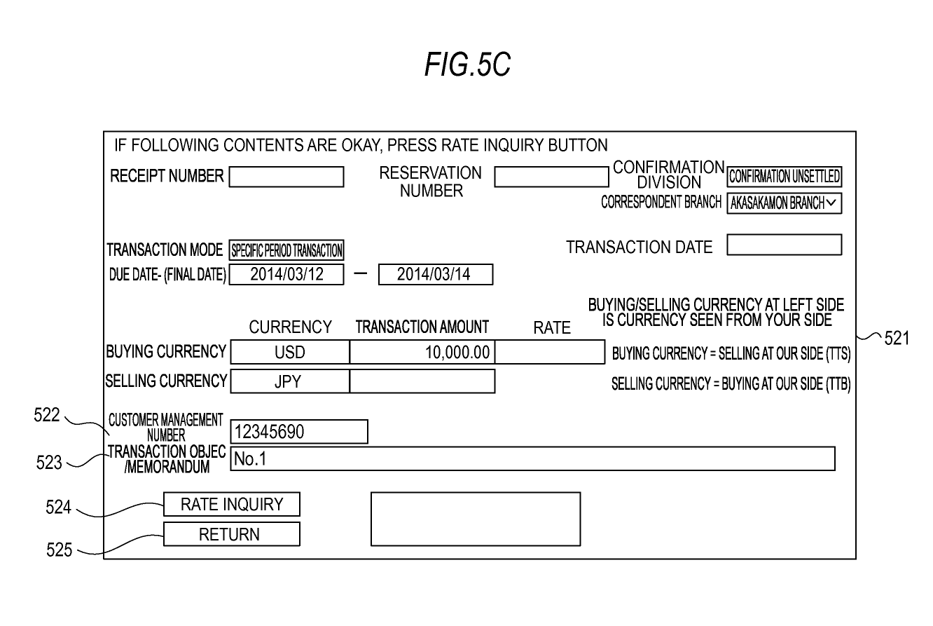

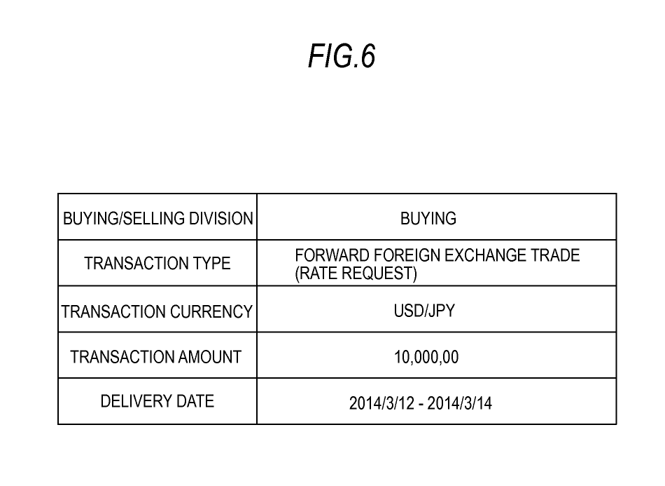

A transaction condition accepting part 303 accepts transaction condition information of a foreign exchange trade transaction input by the customer via an input screen of the foreign exchange trade transaction displayed on the display device 206 of the customer device 101 based on the screen information which is transmitted from the screen information providing part 301 to the customer device 101. The transaction condition information described here is information representing transaction conditions such as a transaction currency and a transaction amount. Details of the transaction condition information are described later by using FIG. 5A, FIG. 5B, FIG. 5C, FIG. 6, and so on.

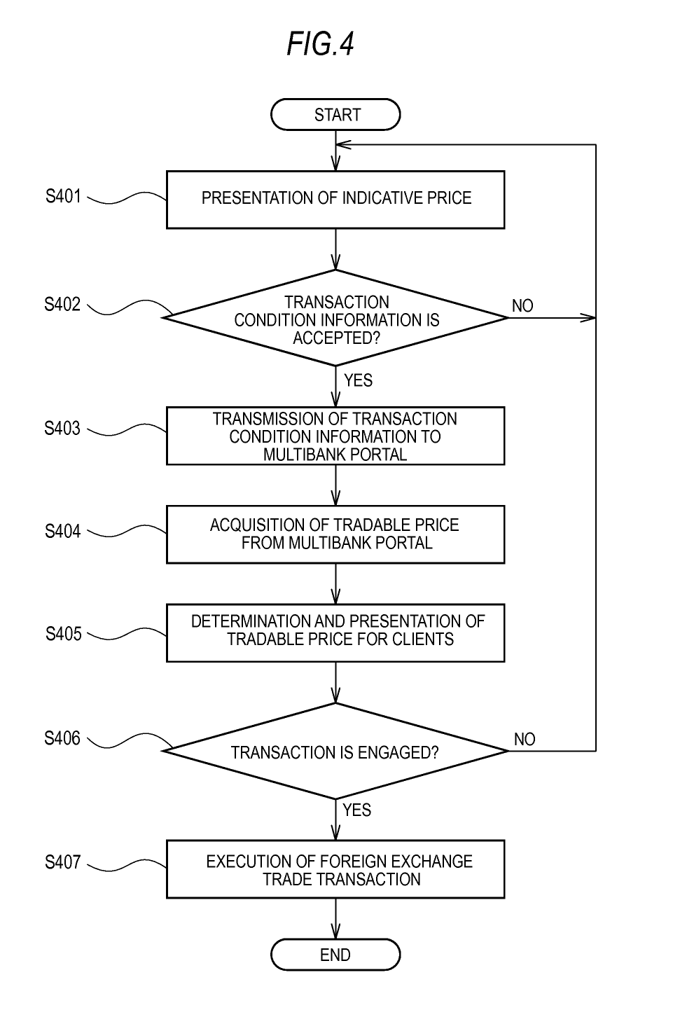

A tradable price acquiring part 304 acquires tradable prices from the plurality of market maker devices 104 via the multibank portal 103 when the transaction condition accepting part 303 accepts the transaction condition information from the customer device 101. More specifically, the tradable price acquiring part 304 transmits the transaction condition information accepted by the transaction condition accepting part 303 from the customer device 101 to the multibank portal 103. The multibank portal 103 transmits the transaction condition information accepted from the tradable price acquiring part 304 to the plurality of market maker devices 104 connected via the network. The market maker device 104 calculates a tradable price in accordance with the transaction condition represented by the transaction condition information accepted from the multibank portal 103, and transmits the calculated tradable price to the multibank portal 103. The multibank portal 103 transmits the tradable prices accepted from the plurality of market maker devices 104 to the foreign exchange trade system 102. The tradable price acquiring part 304 is thereby able to acquire the tradable prices from the plurality of market maker devices 104 via the multibank portal 103. Details of the acquisition process of the tradable prices by the tradable price acquiring part 304 are described later by using a flowchart and so on in FIG. 4. Note that a method in which the market maker device 104 calculates the tradable price in accordance with the transaction condition is defined in advance by each market maker, and therefore, it is not described here.

A tradable price for clients determining part 305 determines a tradable price for clients to be presented to the customer device 101 from the plurality of tradable prices acquired by the tradable price acquiring part 304. For example, the tradable price for clients determining part 305 determines an average value of the plurality of tradable prices as the tradable price for clients. Details of the determination process of the tradable price for clients by the tradable price for clients determining part 305 are described later by using the flowchart and so on in FIG. 4. The screen information providing part 301 transmits the screen information to display a screen presenting the tradable price for clients determined by the tradable price for clients determining part 305 for the customer to the customer device 101. The foreign exchange trade system 102 is thereby able to present the tradable price for clients determined based on the tradable prices of the plurality of market makers for the customer, and therefore, it is possible to present the more proper tradable price for clients compared to a case when a tradable price for clients determined based on only a tradable price of a specific market maker is presented. As a result, the foreign exchange trade transaction between the bank and the customer is easy to be engaged.

When the foreign exchange trade transaction is engaged at the tradable price for clients determined by the tradable price for clients determining part 305, a foreign exchange trade transaction executing part 306 stores the engaged foreign exchange trade transaction information to the HD 204 of the administration server device, and transmits to the customer device 101.

A display controlling part 307 displays various information relating to the foreign exchange trade transaction on the display device 206 of the administration server device.

FIG. 4 is the flowchart illustrating an example of the processes of the foreign exchange trade system 102 of the embodiment.

At S401, the indicative price acquiring part 302 acquires the indicative price from the market maker device 104 via the multibank portal 103 in accordance with a request from the customer device 101. More specifically, the indicative price acquiring part 302 accepts a presentation request of the indicative price via the input screen of the foreign exchange trade transaction displayed on the display device 206 of the customer device 101 based on the screen information which is transmitted by the screen information providing part 301 to the customer device 101, then acquires the indicative price of a market from the multibank portal 103. The screen information providing part 301 transmits the screen information to display the input screen of the foreign exchange trade transaction where the indicative price acquired by the indicative price acquiring part 302 is presented to the customer device 101. The customer device 101 is thereby able to display the input screen of the foreign exchange trade transaction where the indicative price is presented on the display device 206 of the customer device 101.

FIG. 5A, FIG. 5B, FIG. 5C are views each illustrating an example of the input screen of the foreign exchange trade transaction displayed on the display device 206 of the customer device 101.

At first, the customer device 101 accepts the screen information to display the input screen of the foreign exchange trade transaction where the indicative price is presented from the foreign exchange trade system 102, then displays an input screen 501 illustrated in FIG. 5A.

The input screen 501 illustrated in FIG. 5A is described. The indicative prices are displayed at a display field 502. The customer is able to input and select transaction conditions when a transaction is executed while confirming the indicative price displayed on the display field 502. At a selection field 503, it is possible to select either a “rate request” or a “leave order” as an order type. The “rate request” is the order type in which the transaction is executed at the tradable price for clients presented by the bank. The “leave order” is the order type in which the transaction is executed by the customer specifying a value (price) for the bank. At a selection field 504, it is possible to select either a “foreign currency buying (import)” or a “foreign currency selling (export)” as a transaction type. At a selection field 505, it is possible to select either a “fixed date transaction” or a “specific period transaction” as a transaction mode. The “fixed date transaction” is the transaction mode in which a specific date in the future such as, for example, Mar. 1, 2014 is set to be a delivery date. The “specific period transaction” is the transaction mode in which specific dates in the future such as, for example, from Mar. 1, 2014 to Mar. 10, 2014 are defined as a commencement and a termination, and a certain period from the commencement to the termination is set to be the delivery dates. Here, it is assumed that the customer selects the “rate request” as the order type, the “foreign currency buying (import)” as the transaction type, and the “specific period transaction” as the transaction mode.

When a button 506 of the input screen 501 is pressed (selected) by the customer, the customer device 101 notifies the state to the foreign exchange trade system 102. The screen information providing part 301 of the foreign exchange trade system 102 accepts the notification that the button 506 is pressed by the customer from the customer device 101, then transmits screen information to display an input screen 511 illustrated in FIG. 5B to the customer device 101. The customer device 101 accepts the screen information from the foreign exchange trade system 102, then displays the input screen 511 illustrated in FIG. 5B.

The input screen 511 illustrated in FIG. 5B is described. At a selection field 512, a selection of a currency pair is possible. At an input field 513, an input of the transaction amount is possible. Here, the “foreign currency buying (import)” is selected at the selection field 504 of the input screen 501, and USD/JPY is selected at the selection field 512 of the input screen 511, and therefore, the customer is able to input the transaction amount of the buying currency “USD”. At an input field 514, an input of a due date of the delivery date is possible. Here, the “specific period transaction” is selected at the selection field 505 of the input screen 501, and therefore, the customer is able to input the commencement and the termination (final date) as the due date. Note that the customer is able to directly input the due date at the input field 514, or input to the input field 514 by selecting the due date from a calendar displayed on the input screen 511.

When a button 515, a button 516 of the input screen 511 are pressed by the customer, the customer device 101 notifies the state to the foreign exchange trade system 102. The screen information providing part 301 of the foreign exchange trade system 102 accepts the notification that the button 515 is pressed by the customer from the customer device 101, then transmits the screen information to display the input screen 501 illustrated in FIG. 5A to the customer device 101 again. On the other hand, the screen information providing part 301 accepts the notification that the button 516 is pressed by the customer from the customer device 101, then transmits the screen information to display an input screen 521 illustrated in FIG. 5C to the customer device 101. The customer device 101 accepts the screen information from the foreign exchange trade system 102, then displays the input screen 521 illustrated in FIG. 5C.

The input screen 521 illustrated in FIG. 5C is described. At an input field 522, an input of a “customer management number” is possible. At an input field 523, an input of “transaction object/memorandum” is possible. The customer presses a button 524 when an inquiry of the tradable price for clients with the above-stated input contents is desired, and presses a button 525 when the inquiry is not desired or the input contents is to be changed.

When the button 524, the button 525 of the input screen 521 are pressed by the customer, the customer device 101 notifies the state to the foreign exchange trade system 102. The screen information providing part 301 of the foreign exchange trade system 102 accepts the notification that the button 525 is pressed by the customer from the customer device 101, then transmits the screen information to display the input screen 511 illustrated in FIG. 5B to the customer device 101 again. On the other hand, the screen information providing part 301 accepts the notification that the button 524 is pressed by the customer from the customer device 101, then notifies the state to the transaction condition accepting part 303. Then, the transaction condition accepting part 303 transmits the acquisition request of the transaction condition information input by the customer from each of the input screens illustrated in FIG. 5A, FIG. 5B, FIG. 5C to the customer device 101.

FIG. 6 is a view illustrating an example of the transaction condition information. The transaction condition information illustrated in FIG. 6 represents the transaction condition in which a buying/selling division is a buying transaction, a transaction type is a forward foreign exchange trade (rate request), a transaction currency is USD/JPY, a transaction amount is a million currency, and a delivery date is from Mar. 12, 2014 to Mar. 14, 2014.

Return to the description of FIG. 4.

At S402, the transaction condition accepting part 303 judges whether or not the transaction condition information is accepted from the customer device 101. More specifically, when the button 524 of the input screen 521 is pressed by the customer, the transaction condition accepting part 303 transmits the acquisition request of the transaction condition information to the customer device 101 as stated above. Then, the transaction condition accepting part 303 judges whether or not the transaction condition information is accepted from the customer device 101 for the transmitted acquisition request. When the transaction condition accepting part 303 judges that it is accepted, the process is proceeded to S403, and when it judges that it is not accepted, the process is returned to the S401.

At the S403, the tradable price acquiring part 304 transmits the transaction condition information accepted by the transaction condition accepting part 303 at the S402 to the multibank portal 103. The multibank portal 103 transmits the transaction condition information accepted from the foreign exchange trade system 102 to the plurality of market maker devices 104 connected to the multibank portal 103. Each market maker device 104 calculates the tradable price in accordance with the transaction condition represented by the transaction condition information accepted from the multibank portal 103 by a calculation method defined at each market maker, and transmits the calculated tradable price to the multibank portal 103. The multibank portal 103 accepts the tradable prices from the plurality of market maker devices 104, transmits to the foreign exchange trade system 102, and stores at the HD 204 and so on of the foreign exchange trade system 102. Note that the multibank portal 103 may accept the tradable prices from all of the connected market mater devices 104, or may accept the tradable prices only from the market maker devices 104 specified in advance by the administrator via the foreign exchange trade system 102. Here, it is described on an assumption that the multibank portal 103 accepts the tradable prices from all of the connected market maker devices 104.

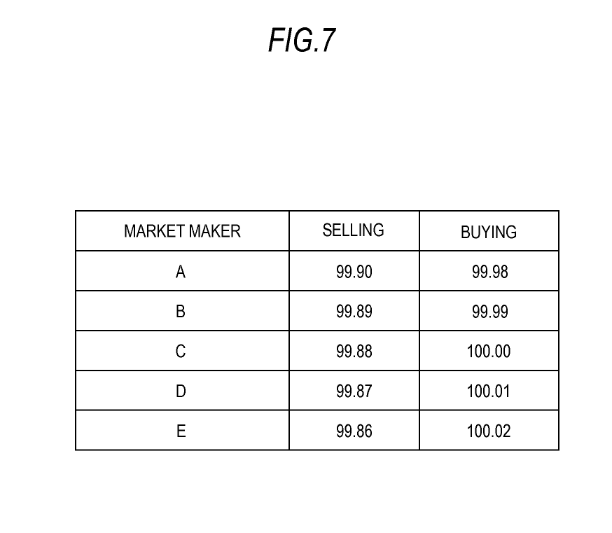

FIG. 7 is a view illustrating an example of a list (listed information) of the tradable prices stored at the HD 204 of the foreign exchange trade system 102. The list of the tradable prices illustrated in FIG. 7 represents the tradable prices (buying tradable prices, selling tradable prices) presented by market makers A to E. Namely, five market maker devices 104 are connected to the multibank portal 103.

Return to the description of FIG. 4.

At S404, the tradable price acquiring part 304 transmits the acquisition request of the tradable price to the multibank portal 103, and acquires the plurality of tradable prices from the multibank portal 103. Here, the tradable price acquiring part 304 may acquire the tradable prices presented by all of the market maker devices 104 from the multibank portal 103, or may acquire only the tradable prices presented by the market maker devices 104 specified in advance by the administrator via the foreign exchange trade system 102. Here, as illustrated in FIG. 7, it is assumed that the tradable prices presented by the market makers A to E are acquired. Here, it may have a constitution in which an input screen where the administrator specifies the market makers to be transaction objects is displayed on the display device 206 of the administration server device. As stated above, it is possible for the foreign exchange trade system 102 to acquire the tradable prices of the plurality of market makers via the multibank portal 103 even though a bank does not individually construct a system relating the foreign exchange trade transaction with each of the plurality of market makers. Namely, the bank is able to acquire the tradable prices of the plurality of market makers without costing a lot for a system development.

At S405, the tradable price for clients determining part 305 determines the tradable price for clients of the foreign exchange trade transaction to be presented to the customer via the customer device 101 based on the plurality of tradable prices which are acquired by the tradable price acquiring part 304 at the S404. Hereinafter, a determination method of the tradable price for clients by the tradable price for clients determining part 305 is described while using a case when the tradable price acquiring part 304 acquires the tradable prices presented by the market makers A to E illustrated in FIG. 7 at the S404 as an example. Note that as it is described by using FIG. 6 and so on, it is described while using a case when the buying/selling division is the buying transaction as an example.

As a first determination method, the tradable price for clients determining part 305 determines an average value of the tradable prices presented by the market makers A to E as the tradable price for clients. Namely, the tradable price for clients determining part 305 determines the tradable price for clients to be 100. As a second determination method, the tradable price for clients determining part 305 determines an average value of the tradable prices in which a maximum value and a minimum value are excluded from among the tradable prices presented by the market makers A to E as the tradable price for clients. Namely, the tradable price for clients determining part 305 determines 100 being the average value of the tradable prices presented by the marketer makers B to D as the tradable price for clients. As a third determination method, the tradable price for clients determining part 305 determines an intermediate value of the tradable prices presented by the market makers A to E as the tradable price for clients. Namely, the tradable price for clients determining part 305 determines 100 being the tradable price presented by the market maker C as the tradable price for clients. As a fourth determination method, the tradable price for clients determining part 305 determines the tradable price of the market maker whose spread is the lowest from among the tradable prices presented by the market makers A to E as the tradable price for clients. Namely, the tradable price for clients determining part 305 determines 99.98 being the tradable price presented by the market maker A as the tradable price for clients. Further, the tradable price for clients determining part 305 may determine a value in which a spread peculiar to the bank determined in advance by each customer is added/subtracted to/from the tradable price for clients determined by the above-stated method as the tradable price for clients. As stated above, it is possible for the foreign exchange trade system 102 to determine a more proper tradable price for clients based on the tradable prices of the plurality of market makers acquired via the multibank portal 103. Namely, as stated above, it is possible for the bank to determine the more proper tradable price for clients based on the tradable prices of the plurality of market makers acquired via the multibank portal 103 even though the bank does not individually establish the software interface with each of the plurality of market makers. Note that a case of the buying transaction when the customer buys the foreign currency from the bank is described as an example, but it is also the same as for a case of a selling transaction.

The screen information providing part 301 transmits screen information to display an input screen of the foreign exchange trade transaction where the tradable price for clients determined by the tradable price for clients determining part 305 is presented to the customer device 101. It is thereby possible for the customer device 101 to display the input screen of the foreign exchange trade transaction where the tradable price for clients is presented on the display device 206 of the customer device 101.

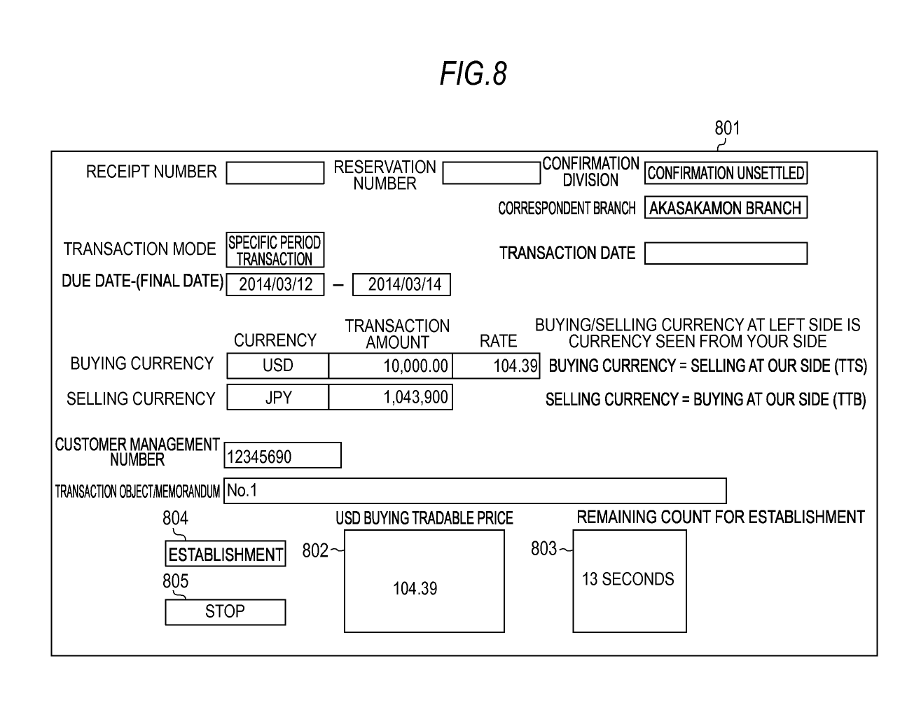

FIG. 8 is a view illustrating an example of an input screen 801 of the foreign exchange trade transaction displayed on the display device 206 of the customer device 101. At a display field 802, the tradable price for clients determined by the tradable price for clients determining part 305 is displayed. In the example in FIG. 8, the tradable price for clients of the buying transaction is displayed. The customer is thereby able to determine whether or not the foreign exchange trade transaction is to be established by referring to the tradable price for clients presented by the foreign exchange trade system 102. Besides, the tradable price for clients determined based on the tradable prices of the plurality of market makers is presented for the customer, and therefore, the contract between the customer and the bank is easy to be engaged compared to a case when the tradable price for clients determined based on only the tradable price of a certain market maker is presented. When the customer establishes the foreign exchange trade transaction at the tradable price for clients displayed on the display field 802, the customer presses a button 804. On the other hand, when the customer does not establish the foreign exchange trade transaction at the tradable price for clients displayed on the display field 802, the customer presses a button 805. A time from the tradable price for clients is presented at the display field 802 until the customer is able to press the button 804 is countdown displayed at a display field 803. For example, when it is displayed as 30 seconds at the display field 803, the contract is not engaged unless the customer presses the button 804 within 30 seconds. When the button 804, the button 805 are pressed by the customer, the customer device 101 notifies the state to the foreign exchange trade system 102.

Return to the description of FIG. 4.

At S406, the foreign exchange trade transaction executing part 306 judges whether or not the foreign exchange trade transaction between the customer and the bank is engaged. More specifically, the foreign exchange trade transaction executing part 306 judges that the foreign exchange trade transaction is engaged when the notification that the customer pressed the button 804 of the input screen 801 is accepted from the customer device 101. On the other hand, the foreign exchange trade transaction executing part 306 judges that the foreign exchange trade transaction is not engaged when the notification that the customer presses the button 805 is accepted or when the notification that the button 804 is not pressed within the time displayed at the display field 803 is accepted. When the foreign exchange trade transaction executing part 306 judges that the foreign exchange trade transaction is engaged, the process is proceeded to S407, and when it is judged that the foreign exchange trade transaction is not engaged, the process is returned to the S401.

At the S407, the foreign exchange trade transaction executing part 306 decides the establishment of the foreign exchange trade transaction at the tradable price for clients determined by the tradable price for clients determining part 305, and stores the foreign exchange trade transaction information to the HD 204 of the administration server device. Further, the foreign exchange trade transaction executing part 306 transmits the foreign exchange trade transaction information to the customer device 101, and the processes in FIG. 4 are finished.

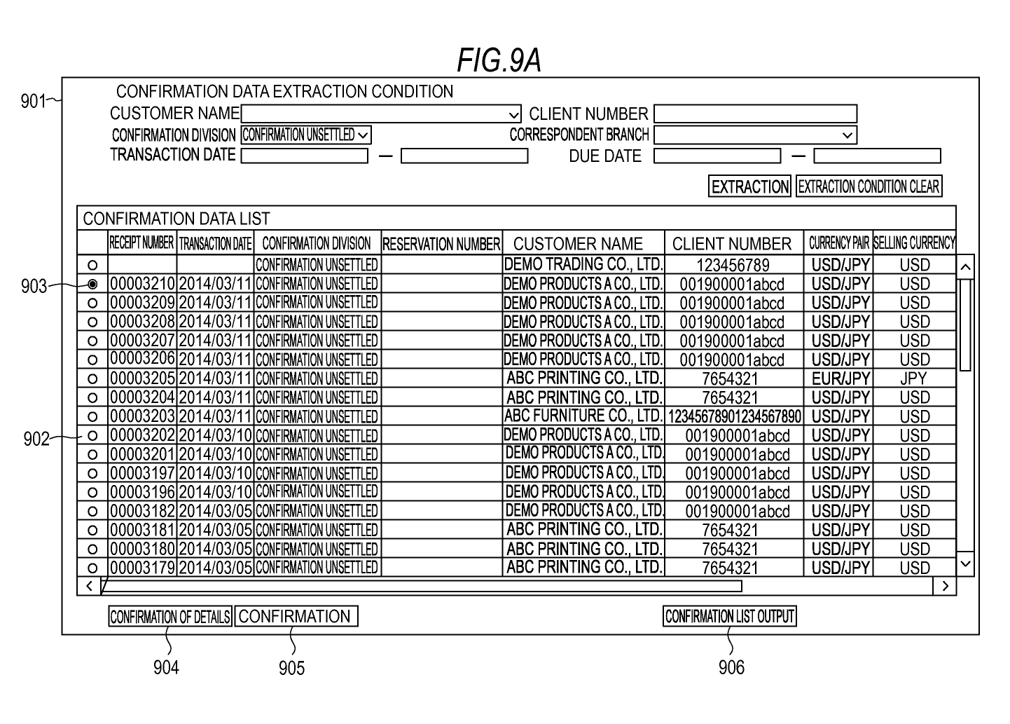

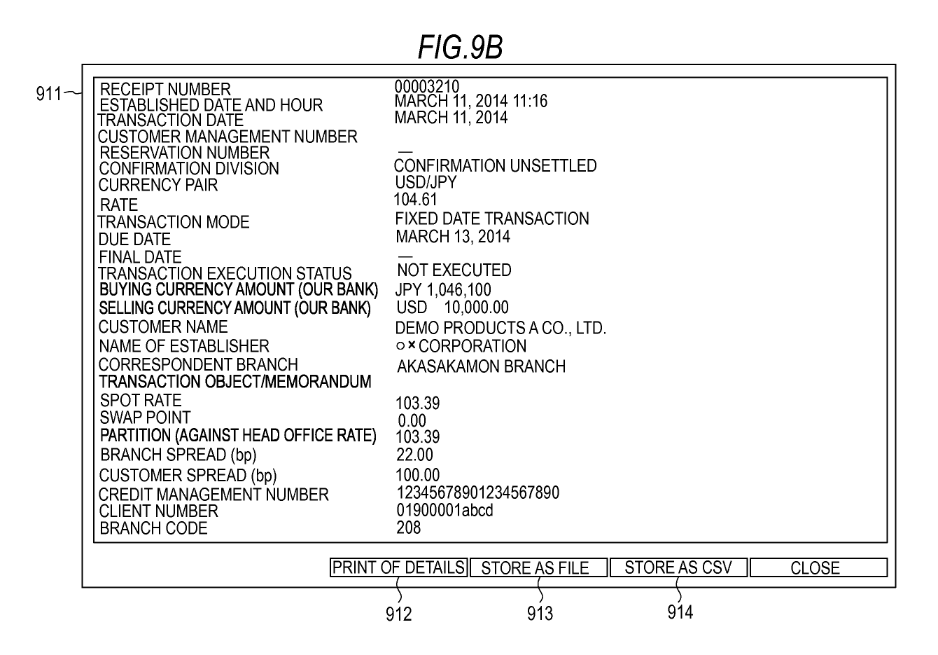

When the foreign exchange trade transaction executing part 306 decides the establishment of the foreign exchange trade transaction, the display controlling part 307 may display confirmation screens of the foreign exchange trade transaction as illustrated in FIG. 9A, FIG. 9B on the display device 206 of the administration server device. Note that the display controlling part 307 may display the confirmation screen not on the display device 206 of the administration server device but on a display of the other information processing device included in the foreign exchange trade system 102. Here, FIG. 9A is a view illustrating an example of a confirmation screen 901 where a transaction list of the foreign exchange trade transaction is displayed. On a display field 902, a transaction list which is not confirmed by the administrator is displayed. When the administrator selects a check box 903 and presses a button 904, the display controlling part 307 displays a confirmation screen 911 where details of the foreign exchange trade transaction information corresponding to the check box 903 is displayed as illustrated in FIG. 9B. The administrator presses buttons 912 to 914 of the confirmation screen 911, and thereby, the display controlling part 307 is able to print-output contents displayed on the confirmation screen 911, and to store as a file. Besides, when the administrator selects the check box 903 and presses a button 905 on the confirmation screen 901, the display controlling part 307 deletes the foreign exchange trade transaction information corresponding to the check box 903 from the display field 902 as it is already confirmed. Besides, when the administrator presses a button 906 on the confirmation screen 901, the display controlling part 307 is able to output the list of the foreign exchange trade transaction information displayed on the display field 902 as a file. As stated above, the administrator is able to confirm, print, store as a data of the details of the foreign exchange trade transaction information established between the bank and the customer, and to appropriately administer the foreign exchange trade transaction information.

As stated above, according to the embodiment, it is possible for the financial institutions such as the local banks to provide the foreign exchange trade system capable of executing the more proper foreign exchange trade transaction without individually establishing the software interface with each of the plurality of market makers. More specifically, the foreign exchange trade system 102 provided by the bank is able to determine the tradable price for clients by acquiring the tradable prices from the plurality of market maker devices 104 connected to the multibank portal 103 by being connected to the multibank portal 103. Namely, it is possible for the bank to present the more proper tradable price for clients for the customer without costing for individually constituting a system relating to the foreign exchange trade transaction with each of the market makers. As a result, the transaction between the bank and the customer is easy to be engaged.

### Embodiment 2

In the embodiment 1, the foreign exchange trade system 102 in which the bank is able to present the more proper tradable price for clients for the customer without individually establishing the software interface with each of the plurality of market makers is described. In the present embodiment, the foreign exchange trade system 102 in which the bank is able to execute a cover deal under a more advantageous condition for the bank without individually establishing the software interface with each of the plurality of market makers is described. Note that the cover deal described in the embodiment is a transaction in which a bank executes a interbank trade for the market maker to avoid a risk for a transaction established with a customer. Besides, the system configuration and the hardware configuration of each device in the embodiment are the same as the embodiment 1.

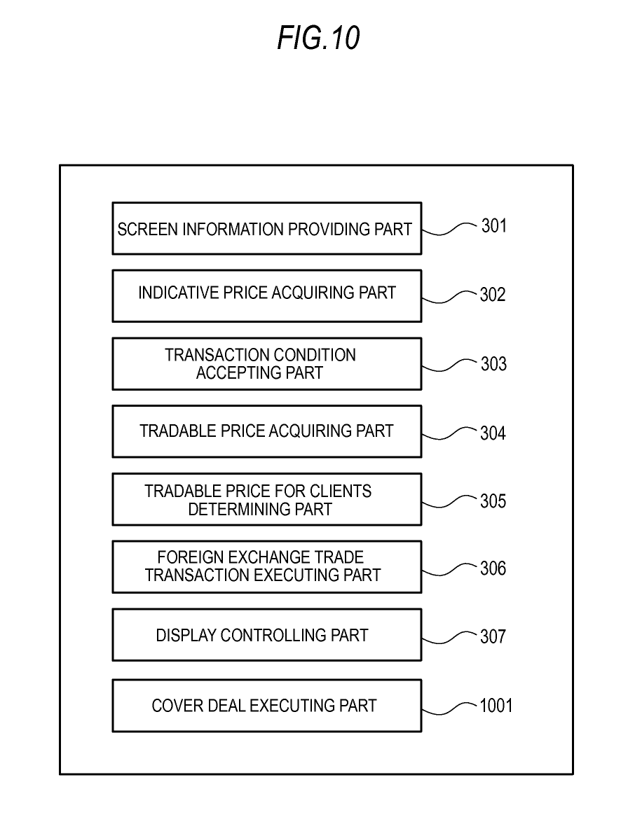

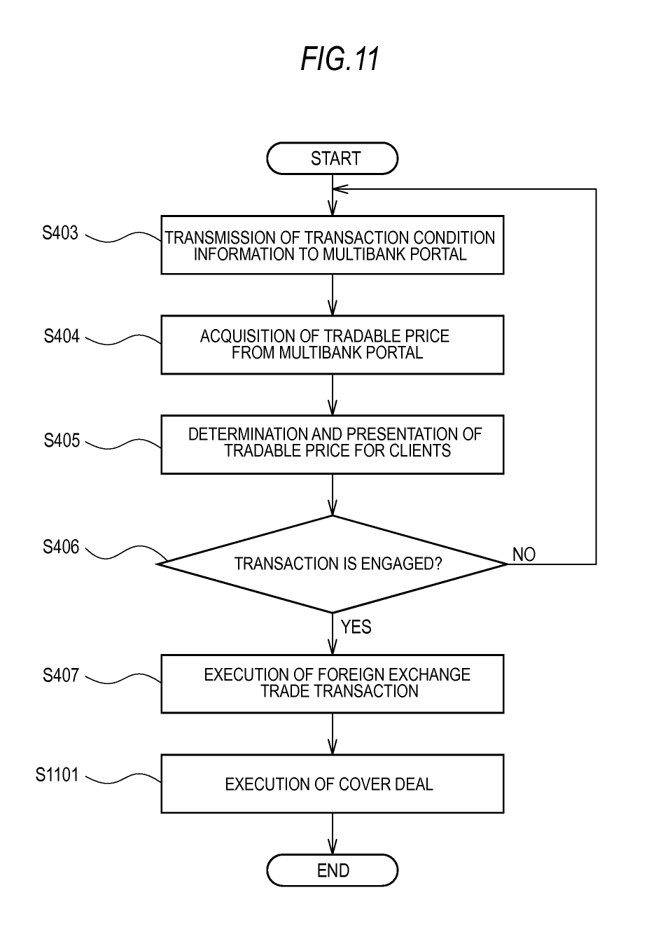

FIG. 10 is a view illustrating an example of a functional configuration of an administration server device included in the foreign exchange trade system 102 of the embodiment. In the functional configuration illustrated in FIG. 10, a cover deal executing part 1001 is added to the functional configuration of the administration server device of the embodiment 1 described by using FIG. 3. Descriptions of the functions similar to the embodiment 1 are not given. Besides, FIG. 11 is a flowchart illustrating an example of processes of the foreign exchange trade system 102 of the embodiment. In the flowchart illustrated in FIG. 11, a cover deal execution process of S1101 is added to the processes from the S403 to the S407 in the flowchart of the foreign exchange trade system 102 of the embodiment 1 which are described by using FIG. 4. Hereinafter, the cover deal execution process executed by the cover deal executing part 1001 at the S1101 is described.

When the foreign exchange trade transaction is established between the bank and the customer, namely, when the customer presses the button 804 on the input screen 801 described by using FIG. 8, the cover deal executing part 1001 calculates a position generated in the established foreign exchange trade transaction, and transmits a transaction request of the cover deal in accordance with the calculated position to the market maker device 104 via the multibank portal 103. Note that the position in the embodiment is a position of a foreign currency. The cover deal executing part 1001 transmits a transaction request of the exchange transaction which cancels the position generated in the foreign exchange trade transaction established between the bank and the customer to the market maker device 104 via the multibank portal 103.

For example, it is assumed that the customer purchases dollar/yen of a million currency from the bank as illustrated in FIG. 6 described in the embodiment 1. In this case, the bank has a selling position of dollar/yen of the million currency, and therefore, it is necessary to purchase the same dollar/yen of the million currency as the cover deal from any of the market makers. Accordingly, the cover deal executing part 1001 transmits a transaction request of the exchange transaction purchasing the dollar/yen of the million currency to any of the market maker devices 104 via the multibank portal 103. Here, it is described as for which one is the market maker device 104 where the cover deal executing part 1001 transmits the transaction request. Note that it is assumed that the market maker devices 104 of the market makers A to E are connected to the multibank portal 103 of the embodiment. Besides, the market makers A to E present the tradable prices illustrated in FIG. 7 which are described in the embodiment 1.

At first, as a first transmission method, the cover deal executing part 1001 transmits the transaction request of the cover deal for the market maker device 104 of the market maker which is specified in advance by the administrator via the foreign exchange trade system 102. As a second transmission method, the cover deal executing part 1001 transmits the transaction request of the cover deal for the market maker device 104 of the market maker which presents the lowest buying tradable price. Namely, the cover deal executing part 1001 transmits the transaction request of the cover deal for the market maker device 104 of the market maker A. Note that here, a case of the buying transaction is described as an example, but in case of a selling transaction, the cover deal executing part 1001 transmits the transaction request of the cover deal for the market maker device 104 of the market maker which presents the highest selling tradable price. As a third transmission method, the cover deal executing part 1001 transmits the transaction request of the cover deal for the market maker device 104 of the market maker which presents the tradable price whose spread is the lowest. Namely, the cover deal executing part 1001 transmits the transaction request of the cover deal for the market maker device 104 of the market maker A. As stated above, the bank is able to execute the cover deal under a more advantageous condition for the bank.

Besides, the cover deal executing part 1001 may execute the cover deal execution process every time when the foreign exchange trade transaction is established, or may execute the cover deal execution process of a plurality of positions in bulk when a total number of the plurality of positions generated by the establishment of a plurality of foreign exchange trade transactions are a threshold value or more defined in advance. According to the latter cover deal execution process, the bank is able to execute the cover deal at a transaction amount in which more gain is expected, and therefore, the cover deal under the more advantageous condition for the bank can be executed.

Besides, when the position generated by the establishment of the foreign exchange trade transaction becomes the threshold value or more defined in advance, the cover deal executing part 1001 may divide and transmit the transaction request of the cover deal to the plurality of market maker devices 104. In this case, the cover deal executing part 1001 determines the number of market maker devices 104 to which the transaction request of the cover deal is to be transmitted in accordance with a value of the position. For example, the cover deal executing part 1001 may transmit the transaction request of the cover deal to the market maker device 104 by dividing into every half-million currency position. Namely, when the position of a million currency is generated, the cover deal executing part 1001 transmits the request of the cover deal by dividing into two market maker devices 104. At this time, the plurality of market maker devices 104 where the cover deal executing part 1001 transmits the transaction request may be specified by the administrator in advance as stated above, or may be in an order from the lowest buying tradable price (in case of the selling tradable price, in an order from the highest one), or may be in an order from the lowest spread. The bank is thereby able to execute the cover deal under the more advantageous condition for the bank because it is possible to execute the cover deal by dividing into the plurality of market makers even when the tradable price is disadvantageous for the bank because the transaction amount is large when the cover deal is executed.

As stated above, according to the embodiment, it is possible for the financial institutions such as the local banks to execute the cover deal under the more advantageous condition without individually establishing the software interface with each of the plurality of market makers. Namely, the bank is able to execute the cover deal under the more advantageous condition without costing for the construction of the system relating to the foreign exchange trade transaction individually with each of the market makers.

### Other Embodiments

Besides, the present embodiment is enabled by executing the following processes. Namely, it is the process in which a software (program) enabling the functions of the above-stated embodiment is supplied to a system or a device via a network or various recording media, and a computer (or a CPU, MPU, and so on) of the system or the device reads out and executes the program.

Besides, in each of the embodiments, it is described that the multibank portal 103 is hardware, but it may be software enabled by the CPU 201 of the server device constituting the multibank portal executing the programs stored at the HD 204 and so on.

As stated above, according to the above-stated respective embodiments, it is possible to provide the foreign exchange trade system capable of executing a more proper foreign exchange trade transaction even if the financial institutions such as the local banks do not individually establish the software interface with each of the plurality of market makers.

According to the present invention, it is possible for financial institutions such as local banks to provide a foreign exchange trade system capable of executing a more proper foreign exchange trade transaction without individually establishing a software interface with each of a plurality of market makers.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A foreign exchange trade system, comprising:
a tradable price acquiring unit which acquires tradable prices from a plurality of market maker devices connected via a multibank portal in accordance with transaction condition information relating to a foreign exchange trade accepted from a customer device; and
a tradable price for clients determining unit which determines a tradable price for clients of the foreign exchange trade presented to a customer via the customer device based on a plurality of tradable prices acquired by the tradable price acquiring unit.

2. The foreign exchange trade system according to claim 1,
wherein the tradable price for clients determining unit determines an average value of the acquired plurality of tradable prices as the tradable price for clients.

3. The foreign exchange trade system according to claim 1,
wherein the tradable price for clients determining unit determines an average value of the tradable prices in which a maximum tradable price and a minimum tradable price are excluded from the acquired plurality of tradable prices as the tradable price for clients.

4. The foreign exchange trade system according to claim 2,
wherein the tradable price for clients determining unit determines a value in which a spread defined by each customer is added/subtracted to/from the average value as the tradable price for clients.

5. The foreign exchange trade system according to claim 1, further comprising:
a cover deal executing unit which executes processes relating to a cover deal in accordance with a position generated in a foreign exchange trade transaction at the tradable price for clients determined by the tradable price for clients determining unit.

6. The foreign exchange trade system according to claim 5,
wherein the cover deal executing unit executes the processes relating to the cover deal by transmitting a transaction request of an exchange transaction which cancels the position to a market maker device defined in advance from among the plurality of market maker devices.

7. The foreign exchange trade system according to claim 5,
wherein the cover deal executing unit executes the processes relating to the cover deal by transmitting a transaction request of an exchange transaction which cancels the position to a market maker device presenting a tradable price whose spread is the lowest from among the plurality of market maker devices.

8. The foreign exchange trade system according to claim 5,
wherein the cover deal executing unit executes the processes relating to the cover deal of a plurality of positions in bulk when a total of the plurality of positions generated in a plurality of foreign exchange trade transactions becomes a threshold value or more defined in advance.

9. The foreign exchange trade system according to claim 5,
wherein the cover deal executing unit executes the processes relating to the cover deal by dividing and transmitting a request of an exchange transaction which cancels the position to the plurality of market maker devices when the position is a threshold value or more defined in advance.

10. The foreign exchange trade system according to claim 1,
wherein the tradable price acquiring unit acquires the tradable prices from the plurality of market maker devices defined in advance from among the plurality of market maker devices.

11. An information processing method executed by a foreign exchange trade system, comprising:
a tradable price acquiring step which acquires tradable prices from a plurality of market maker devices connected via a multibank portal in accordance with transaction condition information relating to a foreign exchange trade accepted from a customer device; and
a tradable price for clients determining step which determines a tradable price for clients of the foreign exchange trade presented to a customer via the customer device based on a plurality of tradable prices acquired by the tradable price acquiring step.

12. A program product for causing a computer to execute:
a tradable price acquiring step which acquires tradable prices from a plurality of market maker devices connected via a multibank portal in accordance with transaction condition information relating to a foreign exchange trade accepted from a customer device; and
a tradable price for clients determining step which determines a tradable price for clients of the foreign exchange trade presented to a customer via the customer device based on a plurality of tradable prices acquired by the tradable price acquiring step.
